(19) United States
(12) Patent Application Publication
(10) Pub. No.: US 2004/0146094 A1
(43) Pub. Date: Jul. 29, 2004

(54) Method and apparatus for rake combining based upon signal to interference noise ratio

(76) Inventors: Ning Kong, San Diego, CA (US); Ian Raphagen, San Diego, CA (US); Michiel Lotter, San Diego, CA (US)

Correspondence Address: COOLEY GODWARD, LLP, 3000 EL CAMINO REAL, 5 PALO ALTO SQUARE, PALO ALTO, CA, 94306, US

(21) Appl. No.: 10/703,138

(22) Filed: Nov. 5, 2003

Related U.S. Application Data
(60) Provisional application No. 60/425,424, filed on Nov. 12, 2002.

(51) Int. Cl. H04B 1/707

(52) U.S. Cl. 375/148; 375/150

(57) ABSTRACT

A method and apparatus for recovering information from a spread spectrum information signal included within a composite signal received from a signal propagation medium are disclosed herein. The method includes correlating time-offset versions of the composite signal with a spreading sequence in order to produce a plurality of correlation signals. The method further includes generating weighting factors based upon multipath channel gain characteristics so as to maximize a signal to interference plus noise ratio (SINR) of an estimate of the information. A plurality of weighted symbol streams are generated by processing the plurality of correlation signals in accordance with the weighting factors. The estimate of the information is then produced by combining the plurality of weighted symbol streams.

### CROSS-REFERENCE TO RELATED APPLICATIONS

This application claims priority under 35 U.S.C. §119(e) to U.S. Provisional Application No. 60/425,424, entitled METHOD AND APPARATUS FOR RAKE COMBINING BASED UPON SIGNAL TO INTERFERENCE NOISE RATIO.

### FIELD OF THE INVENTION

The present invention relates to Code Division Multiple Access (CDMA) communication systems and, in particular, to a technique for canceling pilot signal interference within such systems.

### BACKGROUND OF THE INVENTION

Recently, various forms of Code-Division Multiple Access (CDMA) wireless communication systems have become standardized and deployed in a number of countries. More specifically, such standards include IS-95, cdma2000 and WCDMA. In CDMA systems, users are distinguished from each other by being assigned different code sequences.

Within CDMA systems, a “pilot” signal is often transmitted in order to facilitate the performance of a number of operations at a receiver. For example, the pilot signal may be utilized by the receiver to establish timing and frequency synchronization with the transmitter and to estimate channel characteristics. Each pilot signal is typically uniquely associated with a particular base station in order to enable a mobile station to identify the base station from which a pilot signal is received. Generation of a pilot signal is typically effected by “covering” a known data pattern with a known Walsh code and spreading the result with a known pseudo-noise (PN) sequence.

RAKE receivers operative to implement diversity reception techniques are often deployed within CDMA systems to extract pilot, user traffic and other data from signal energy received over a channel. Each “finger” or diversity branch of the RAKE receiver processes its assigned multipath component and recovers the associated pilot signal, user traffic and other data. In coherent CDMA system implementations, recovered pilot signal information is generally used to estimate the characteristics of the channel (e.g., amplitude and phase) needed for coherent detection within the RAKE receiver. The pilot signal is designed to be generated so as to be orthogonal to the spreading codes assigned to system users in order to avoid engendering interference during the data demodulation process. However, in the case of dispersive multipath channels, the various received multipath signal components will be mutually non-orthogonal and will hence create undesirable interference. Specifically, with respect to a given multipath signal component, unwanted contributions due to the multipath components of the other channels and the pilot signal tend to introduce interference.

Undesirably, conventional RAKE receivers are not designed to mitigate the effects of such interchannel multipath interference. In particular, such RAKE receivers generally utilize maximal ratio combining (MRC) schemes in combining the different multipath components processed thereby. Only under certain special conditions (e.g., there is no multipath or all of the multipaths have the same average power) will MRC techniques produce optimal results.

With the advent of so-called third generation or “3G” wireless systems, research has been carried out in an attempt to develop a RAKE combining scheme which mitigates the effects of interference. For example, in one proposed approach the interference correlation among different multi-paths is utilized to find a set of combining weights which maximize a signal-to-interference-plus-noise ratio (SINR), rather than the maximization of SNR contemplated by MRC techniques. In this approach, training sequences are used to adapt the combining weights such that the interference is minimized. Unfortunately, in one implementation of this approach a correlation matrix is required to be calculated, which significantly increases complexity. In other implementations, the adaptation of the combining weights has been found to be significantly influenced by fading, which degrades performance. As a consequence, MRC techniques are still being used within the RAKE receivers being developed for 3G systems. However, since the MRC process remains susceptible to the deleterious effects of interference, it has been deployed in conjunction with various separate interference reduction schemes (e.g., parallel or serial interference cancellation, pilot interference cancellation, and so on), thereby increasing cost and complexity.

Accordingly, there exists a need for a low-complexity combining scheme for RAKE receivers that is less susceptible to the effects of multipath interference than are conventional combining techniques.

### SUMMARY OF THE INVENTION

In summary, the present invention relates to a method for recovering information from a spread spectrum information signal included within a composite signal received from a signal propagation medium. The method includes correlating time-offset versions of the composite signal with a spreading sequence in order to produce a plurality of correlation signals. The method further includes generating weighting factors so as to maximize a signal to interference plus noise ratio (SINR) of an estimate of the information. Consistent with one aspect of the invention, generation of the weighting factors involves computing gain characteristics of a plurality of multipath channels traversed by a corresponding plurality of multipath components of the composite signal. A plurality of weighted symbol streams are generated by processing the plurality of correlation signals in accordance with the weighting factors. The estimate of the information is then produced by combining the plurality of weighted symbol streams.

The invention relates to an apparatus for recovering information from a spread spectrum information signal included within a composite signal received from a signal propagation medium. The apparatus includes a correlation arrangement operative to correlate time-offset versions of the composite signal with a spreading sequence in order to produce a plurality of correlation signals. The apparatus further includes a plurality of weighting arrangements disposed to generate a plurality of weighted symbol streams by processing the plurality of correlation signals in accordance with a set of weighting factors. A combiner coupled to the plurality of weighting arrangements is disposed to produce the estimate of the information carried by the spread spectrum signal. The set of weighting factors are generated by a weight generator so as to maximize a signal to interference plus noise ratio (SINR) of the estimate of the information. The process of generating the weighting factors typically involves computing gain characteristics of a plurality of multipath channels traversed by a corresponding plurality of multipath components of the composite signal.

### BRIEF DESCRIPTION OF THE DRAWINGS

For a better understanding of the nature of the features of the invention, reference should be made to the following detailed description taken in conjunction with the accompanying drawings, in which:

FIG. 1 is a block diagram of a mobile unit receiver within which may be implemented the SINR-based combining scheme of the present invention.

FIG. 2 is a block diagram of a RAKE receiver module included within the mobile unit receiver of FIG. 1.

FIG. 3 provides an illustrative representation of a model of generation and transmission of an exemplary downlink signal within a spread spectrum communication system.

FIG. 4 illustratively represents a RAKE receiver having receiver fingers configured to implement to implement the optimal combining scheme of the present invention.

FIG. 5 depicts a RAKE receiver which incorporates weighting elements comprising simplified versions of the weighting elements included within the RAKE receiver of FIG. 4.

### DETAILED DESCRIPTION OF THE INVENTION

The present invention recognizes that the diversity combining schemes currently used in the RAKE receivers are generally not optimized for operation under the conditions typically existing within a multiple access environment serving mobile units. In particular, the present invention is directed to a system and method for diversity combining based upon maximization of a signal-to-interference-plus-noise-ratio (SINR). The inventive approach to diversity combining may be implemented using a low-complexity arrangement which has been found to offer improved bit error rate (BER) performance relative to conventional techniques.

The optimal SINR-based combining scheme of the present invention may be implemented within a CDMA receiver disposed to process plural multipath signal components. As is known, a received CDMA signal generally is comprised of a number of multipath components, each of which is typically separately processed by an associated “finger” of a CDMA receiver. From the perspective of a given multipath component, the multipath components processed by other receiver fingers constitute undesirable signal interference. As is described below, the SINR-based combining scheme of the present invention advantageously exhibits increased immunity to the potentially adverse consequences of such interference.

### RAKE Receiver Architecture

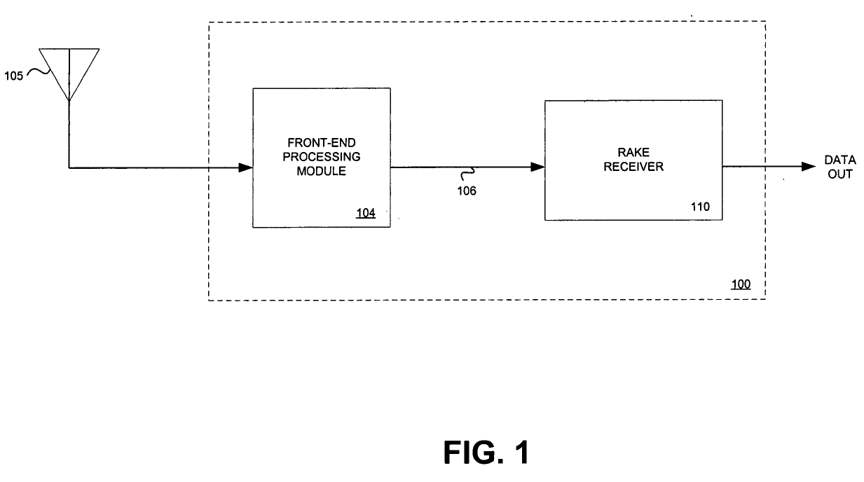

Turning now to FIG. 1, a block diagram is provided of a mobile unit receiver 100 within which may be implemented the SINR-based combining scheme of the present invention. The mobile unit receiver 100 is presumed to be disposed within a mobile unit configured to operate within a CDMA communication system. The mobile unit receiver 100 includes a front-end processing module 104 which receives forward link signal components collected by an antenna 105. The forward link signal components arise upon transmission by a transmitter (not shown) of a CDMA communication signal though a multipath propagation environment to the mobile unit. The front-end processing module 104 filters, amplifies, downconverts and digitizes the received forward link signal in order to create a set of received data samples 106 provided to a RAKE receiver module 110. In operation, the RAKE receiver module 110 functions to generate recovered symbols on the basis of the data samples 106 provided by the front-end processing module 104. As is described below,the RAKE receiver module 110 is configured to process the multiple components of the received signal arriving via different signal paths, or “multipaths”.

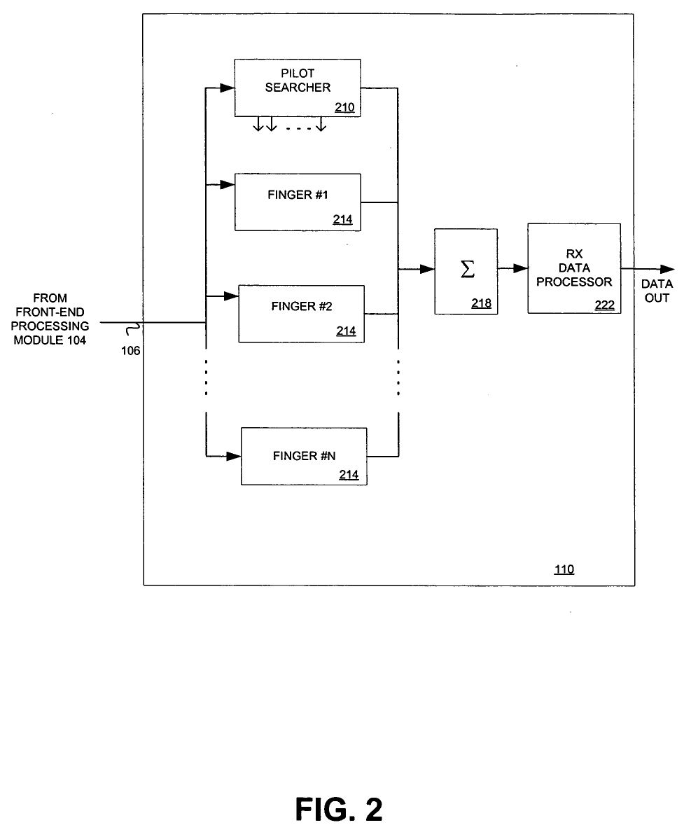

Referring now to FIG. 2, a block diagram is provided of the RAKE receiver module 110. The RAKE receiver module 110 includes a number of diversity processing paths 214, or “fingers”, each of which digitally process the data samples 106 corresponding to an instance of the forward link signal received over one such signal path. Each finger 214 processes a particular multipath component of the received signal. Such processing includes despreading the data samples 106 using a PN sequence in time alignment with the multipath signal being processed by the applicable finger 214. The resultant candidate symbol streams from the fingers 214 are provided to a diversity combiner module 218, which synthesizes a single composite symbol stream on the basis of these candidate streams. A receive (RX) data processor 222 then receives and decodes the composite symbol stream from RAKE receiver module 110 in order to recover the user data and message information transmitted on the forward link.

As mentioned above, each of the fingers 214 are used to demodulate and otherwise process an instance of the forward link signal received over a different air path of the multipath propagation environment. Each finger 214 is of substantially identical structure, but operates on the basis of different parameters characteristic of its associated air path (e.g., gain, phase and time delay). The RAKE receiver module 110 further includes a pilot searcher 210 for detecting various multipath components of the pilot signal being received. This searching is effected using known techniques to correlate the received signal with a PN sequence associated with the pilot signal. The pilot searcher provides the detected offsets in the PN signal associated with each multipath component to a finger 214 assigned to process such multipath component.

Various conventional aspects of the structure and operation of a RAKE receiver have now been described. Attention is now directed to a description of a system in which may be incorporated an exemplary implementation of the SINR-based combining scheme of the present invention.

### System Model

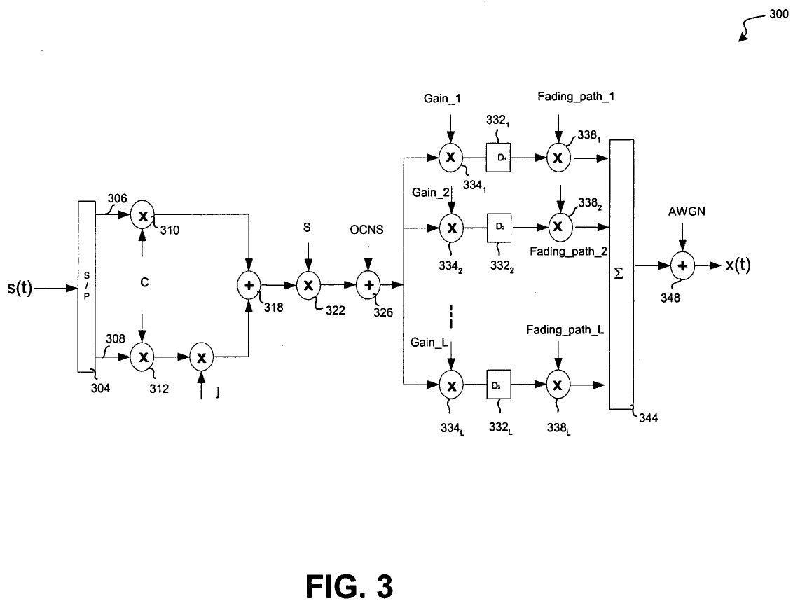

Referring now to FIG. 3, an illustrative representation is provided of a model 300 of generation and transmission of an exemplary downlink signal within a spread spectrum communication system. As shown in FIG. 3, the signal s(t) to be transmitted is initially modulated by in-phase (I) and quadrature phase (Q) pseudo noise (PN) spreading sequences within a serial to parallel (S/P) input module 304. The resultant I and Q spread signals 306 and 308 are then channelized using first and second code spreaders 310 and 312, respectively. This channelization may be effected using a set of orthogonal Walsh spreading codes, where each different code corresponds to a particular user. The channelized I and Q signals are then combined within a summer 318 and modulated using a complex scrambling sequence (S) via multiplier 322. Although not shown in FIG. 3, the channelized I and Q signals are each filtered by FIR filters, up-converted to radio frequency (RF) signals, combined and transmitted via an antenna over the air to one or more user stations. As a result, the RF transmitted signal includes a summation of all channels (i.e., data and pilot channels) generated within the system of FIG. 3, which is represented by the addition of an orthogonal channel noise source (OCNS) by adder 326. That is, the OCNS represents the interference associated with other system users relative to the input signal s(t).

Referring again to FIG. 3, the output of adder 326 is split into L separate multipaths having different delays 332 and each path is distorted by propagation attenuation and Rayleigh fading. This distortion arising from propagation attenuation and Rayleigh fading is represented by way of multipliers 334 and 338, respectively. At a receiver (not explicitly shown in FIG. 3), the composite signal L multipath signals arrive as a composite signal as indicated by the summation of the L multipath signals within a combiner 344. Finally, white Gaussian noise (AWGN) is added 348 to the output of the combiner 344.

It is observed that the interference power due to the OCNS within each of the L multipath signals, and hence arising within each receiver finger 214, may be represented by composite interference signal comprised of a sum of weighted sources of OCNS. Specifically, each such OCNS is weighted by a different gain factor depending upon the attenuation of the associated multipath channel. However, the different delayed versions of signals (including pilot and different data channels) processed by ones of the fingers 214 appear to other of the fingers 214 as interference. As is described hereinafter, the diversity combining scheme of the present invention functions to mitigate the effects of such interference.

### Derivation of Optimum Combining Scheme

Based upon the optimum criterion of maximal signal-to-interference-plus-noise ratio (SINR), the optimal combining (“OC”) weights for each finger 214 of the RAKE receiver module 110 to achieve maximal SINR may be expressed as follows:

w=Rᵢ₊ₙ⁻¹r_{xd}* (1)

where Rᵢ₊ₙ is the correlation matrix of the interference and noise, and where r_{xd}* is an L-element vector of the complex conjugates of the gains of the L multipath channels (i.e., the MRC weights). Since the inter-path interference and noise are uncorrelated, Rᵢ₊ₙ is a diagonal matrix. The elements of Rᵢ₊ₙ, denoted by rᵢⱼ, are as follows:

$${r}_{ij} = \{ \begin{matrix}{\sum }_{l \neq j}^{L} {α}_{l}^{2} c + N {σ}_{n}^{2} , & i = j \\ 0 , & i \neq j\end{matrix} \qquad ( 2 )$$

where α_{L}² is the instantaneous channel gain of the 1^{th} path (each path will generally have a different gain since each will also generally exhibit a different path loss), N is representative of the thermal noise, and where the parameter “c” is defined as c≡c₁+c₂. In this regard c₁ represents the multi-path pilot and self-interference average power excluding the effects of channel gain, and c₂ is the average power of the “other user interference” (i.e., OCNS) power absent channel gain effects. As is implied by Equation (2), the value of the parameter “c” is the same for all fingers 214. This is because the magnitudes of the terms c₁ and c₂ inversely vary relative to each other in accordance with the number of active users presently being served within the system of FIG. 3. Specifically, since the c₂ parameter is used to model the equivalent “other users”, the value of this term is smaller (and the value c₁ larger) when there are fewer users (i.e., more power allocated to the desired signal), and vice versa.

As mentioned above, r_{xd}* of Equation (1) is simply representative of the MRC weights, each of which represents the complex conjugate of the channel impulse response of one of the L multipath channels, i.e., r_{xd}*=[h₁* h₂* . . . h_{L}*], where [h₁* h₂* . . . h_{L}*] are the L multipath channel impulse responses. Since the thermal noise (N) is much less than the interference power, the OC weights may be expressed as follows:

$${w}_{oc} = {R}_{i + n}^{- 1} {r}_{xd}^{*} = \\ [ \begin{matrix}\frac{1}{{\sum }_{i \neq 1}^{L} {α}_{i}^{2}} & 0 & 0 & 0 \\ 0 & \frac{1}{{\sum }_{i \neq 2}^{L} {α}_{i}^{2}} & 0 & 0 \\ 0 & 0 & ⋰ & 0 \\ 0 & 0 & 0 & \frac{1}{{\sum }_{j \neq L}^{L} {α}_{i}^{2}}\end{matrix} ] [ \begin{matrix}\begin{matrix}{h}_{1}^{*} \\ {h}_{2}^{*}\end{matrix} \\ ⋮ \\ {h}_{L}^{*}\end{matrix} ] \qquad ( 3 )$$

In Equation (3) above, the gain of each channel (αₗ²) will be obtained using conventional techniques based upon the received pilot signal. It follows that the solution of Equation (3) requires determination of Rᵢ₊ₙ. However, since Rᵢ₊ₙ is a diagonal matrix, the OC weights may be determined simply by computing the value of each diagonal element of Rᵢ₊ₙ. This straightforward approach is at least in part facilitated by the fact that the parameter c is effectively removed from the calculations, since it is of the same value for all paths. Accordingly, although Rᵢ₊ₙ defines an interference correlation matrix, it has been simplified in the manner described above so as not to be explicitly dependent upon interference levels. Rather, Rᵢ₊ₙ is instead only dependent upon the instantaneous channel gains of all paths (which are representative of the interference power within the corresponding channel paths). In accordance with the invention, it is therefore unnecessary to determine interference power, as is required by other techniques.

As may also be apparent from Equation (3), it is a feature of the present invention that the unequal distribution of power among the various multipath components of the desired signal is taken into account. In contrast, other combining techniques tend to simplistically assume a uniform power distribution among such “self-interfering” multipath components.

### Implementation of Optimum Combining Scheme

As is described herein, the diversity combining apparatus of the present invention may be configured to provide improved performance relative to conventional combining approaches such as MRC with minimal increase in complexity. In accordance with the invention, it is recognized that calculation of the interference power matrix Rᵢ₊ₙ may not be performed through separation of the desired signal from the interference power. However, analysis of the structure of Rᵢ₊ₙ reveals that the OC weights for each multi-path correspond to the weight that would be assigned using MRC techniques divided by the interference power of that path. This implies that use of the OC weights of the present invention results not only in compensation for fading but also for interference. Specifically, weights derived using MRC techniques effectively de-rotate the received signal to compensate for channel phase rotation and include a gain factor that is proportional to the channel gain. In this way “better” channels are enabled to play a greater role than “poor” channels in the combining process. However, the OC weights of the present invention further contemplate a gain that is proportional to the applicable interference power, which increases the contribution of channels experiencing relatively lesser amounts of interference power. Since conventional approaches to estimating such interference power may be unreliable and difficult to implement, the following provides a method of obtaining equivalent information more reliably. To this end, it is noted that

$$\frac{1}{{\sum }_{i \neq k}^{L} {α}_{i}^{2}} < \frac{1}{{\sum }_{i \neq j}^{L} {α}_{i}^{2}}$$

is true if and only if αₖ²>αⱼ², or simply |αₖ|>|αⱼ|, and αₖ²,k=1, 2, . . . can be more reliably measured using the received pilot signal. Therefore, a matrix R_{equ} is used in lieu of Rᵢ₊ₙ⁻¹, where R_{equ}⁻¹ may be expressed as:

$${R}_{equ}^{- 1} = [ \begin{matrix}\vert {α}_{1} \vert & & & \\ & \vert {α}_{2} \vert & & \\ & & ⋰ & \\ & & & \vert {α}_{L} \vert\end{matrix} ]$$

and |αₖ| is the absolute value of the gain of the k^{th} of the L multipath channels. Hence

$${R}_{equ} = [ \begin{matrix}\vert {h}_{1} \vert & & & \\ & \vert {h}_{2} \vert & & \\ & & ⋰ & \\ & & & \vert {h}_{L} \vert\end{matrix} ]$$

In order to prevent an increase in required dynamic range from occurring as a consequence of multiplication by the absolute value of the channel gain, all channel gains are normalized to the absolute value of the greatest channel gain.

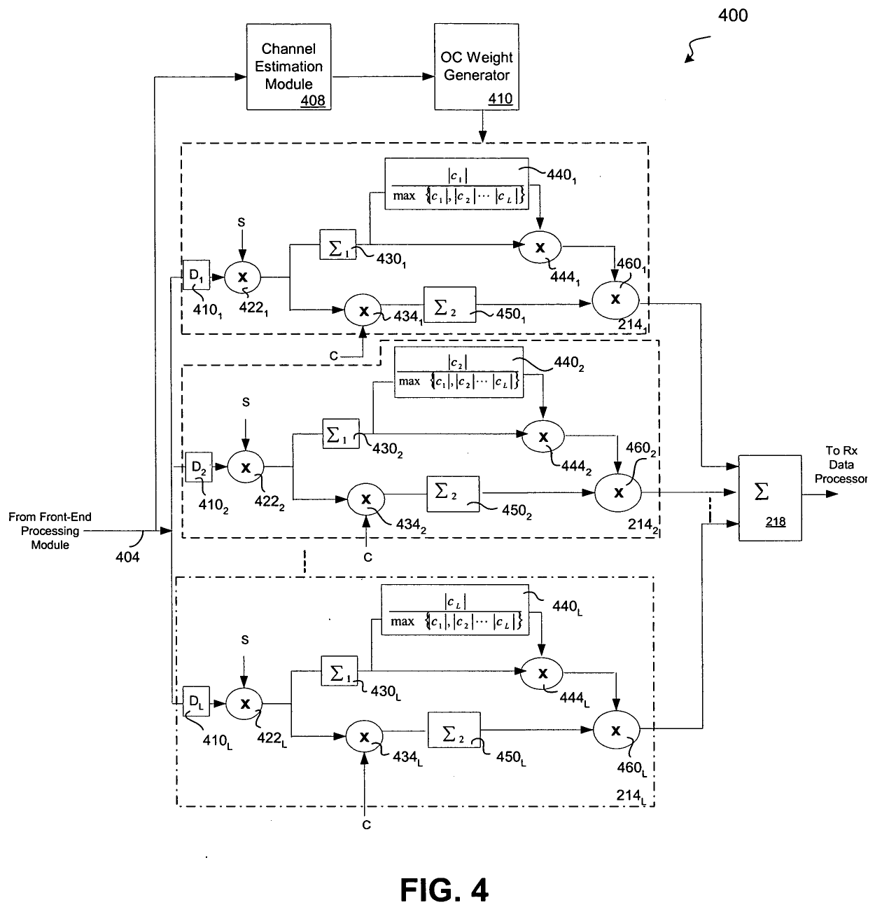

FIG. 4 illustratively represents a RAKE receiver 400 having receiver fingers 414 configured to implement the optimal combining scheme of the present invention. For purposes of clarity, the pilot searcher module of the RAKE receiver 400 has been omitted from FIG. 4. As shown, samples 404 of a received signal are provided to the receiver fingers 414 and to a channel estimation module 408 by a front-end processing module (not shown). The channel estimation module 408 produces estimated channel information used by an OC weight generator 410 in calculating OC weighting values in the manner described above. In particular, the channel estimation module 408 will typically be implemented to determine the gain of each channel (αₗ²) using conventional techniques based upon the received pilot signal.

During operation of the RAKE receiver 400, each finger 414 processes an instance of the received signal associated with a particular diversity signal path. The samples 404 are provided to a delay element 410 of each receiver finger 414 and the delayed samples are then multiplied by the complex scrambling sequence (S) within first multipliers 422. The output of each multiplier 422 is provided to a first summation module 430 and second multiplier 434 of each receiver finger 414. Each first summation module 430 sums samples from the applicable multiplier 422, and provides the result to an OC weighting element 440 and third multiplier 444. As shown, each second multiplier 434 also receives a user-specific spreading code C (e.g., selected from a set of orthogonal Walsh spreading codes) and delivers its output to a second summation module 450. Finally, the output of each third multiplier 444 is combined with the output of the corresponding second summation module 450 by an output multiplier 460. The outputs of the output multipliers 460 correspond to the candidate symbol streams generated by the fingers 414, which are combined within diversity combiner module 218.

Referring to FIG. 4, the quantity defining the value of each weighting element 440, i.e.,

$$\frac{\vert {h}_{i} \vert}{max \{ \vert {h}_{1} \vert , \vert {h}_{2} \vert ⋯ \vert {h}_{L} \vert \}} ,$$

may be implemented in a simplified manner. In particular, since |hᵢ|≈L+0.25S, for i=1,2, . . . , L, where L is the absolute value of the larger part (in absolute value) of the real part and the imaginary part of hᵢ and S is the absolute value of the smaller part (in absolute value) of the real part and the imaginary part of hᵢ. The ratio of

$$\frac{\vert {h}_{i} \vert}{max \{ \vert {h}_{1} \vert , \vert {h}_{2} \vert ⋯ \vert {h}_{L} \vert \}}$$

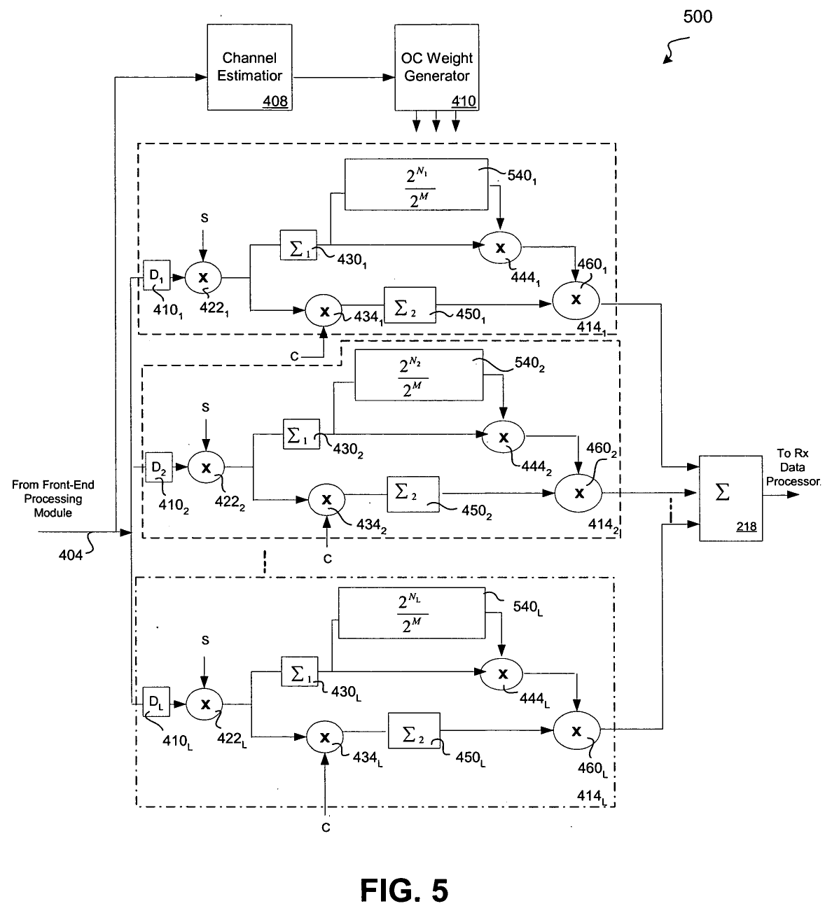

can be approximated as

$$\frac{\vert {h}_{i} \vert}{max \{ \vert {h}_{1} \vert , \vert {h}_{2} \vert ⋯ \vert {h}_{L} \vert \}} = \frac{\vert {h}_{i} \vert}{\vert {h}_{max} \vert} \approx \frac{{L}_{i}}{{L}_{max}} \approx \frac{{2}^{N}}{{2}^{M}} ,$$

where 2^{N-1}≦Lᵢ≦2_{N} and 2^{M-1}≦Lₘₐₓ≦2^{M}. If this arrangement does not yield sufficient accuracy using a given number of bits (i.e., as represented by M and N), the number of bits may be increased until a desired level of accuracy is attained. Use of this approach permits the weighting elements 440 to be implemented in a simplified manner. Specifically, FIG. 5 depicts a RAKE receiver 500 which incorporates weighting elements 540 comprising simplified versions of the weighting elements 440. With the exception of the simplified weighting elements 540, the RAKE receiver 500 is substantially identical to the RAKE receiver 400. As may be appreciated by reference to FIG. 5, the simplified OC implementation 500 advantageously uses only slightly more (i.e., 2) shift operations per finger relative to conventional approaches such as MRC. In sum, the RAKE finger weights computed consistent with one embodiment of the present invention comprise a set of conventional MRC weights further multiplied by the applicable finger channel gains, which results in mitigation of multipath interference. In order not to increase the dynamic range of the applicable signal by virtue of the multiplication operation, the absolute gain value of each channel is normalized by the greatest absolute value of all the channel gains.

The foregoing description, for purposes of explanation, used specific nomenclature to provide a thorough understanding of the invention. However, it will be apparent to one skilled in the art that the specific details are not required in order to practice the invention. In other instances, well-known circuits and devices are shown in block diagram form in order to avoid unnecessary distraction from the underlying invention. Thus, the foregoing descriptions of specific embodiments of the present invention are presented for purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. It is intended that the following Claims and their equivalents define the scope of the invention.

What is claimed is:

1. A method for recovering information from a spread spectrum information signal included within a composite signal received from a signal propagation medium, said method comprising:
correlating time-offset versions of the composite signal with a spreading sequence in order to produce a plurality of correlation signals;
generating weighting factors so as to maximize a signal to interference plus noise ratio (SINR) of an estimate of the information;
generating a plurality of weighted symbol streams by processing the plurality of correlation signals in accordance with the weighting factors; and
producing the estimate of the information by combining the plurality of weighted symbol streams.

2. The method of claim 1 wherein said step of generating weighting factors includes computing gain characteristics of a plurality of multipath channels traversed by a corresponding plurality of multipath components of the composite signal.

3. The method of claim 2 wherein said step of generating weighting factors includes determining a first of said weighting factors by computing a ratio of a first of said gain characteristics to a maximum of said gain characteristics.

4. The method of claim 3 wherein said step of generating weighting factors includes determining a second of said weighting factors by computing a ratio of a second of said gain characteristics to the maximum of said gain characteristics.

5. A method for recovering information from a spread spectrum information signal included within a composite signal received from a signal propagation medium over a set of multipath channels, said method comprising:
correlating time-offset versions of the composite signal with a spreading sequence in order to produce a plurality of correlation signals;
generating weighting factors in accordance with gain characteristics of the set of multipath channels;
generating a plurality of weighted symbol streams by processing the plurality of correlation signals in accordance with the weighting factors; and
producing the estimate of the information by combining the plurality of weighted symbol streams.

6. The method of claim 5 wherein said step of generating weighting factors includes determining a first of said weighting factors by computing a ratio of a first of said gain characteristics to a maximum of said gain characteristics.

7. The method of claim 6 wherein said step of generating weighting factors includes determining a second of said weighting factors by computing a ratio of a second of said gain characteristics to the maximum of said gain characteristics.

8. An apparatus for recovering information from a spread spectrum information signal included within a composite signal received from a signal propagation medium, said apparatus comprising:
a correlation arrangement operative to correlate time-offset versions of the composite signal with a spreading sequence in order to produce a plurality of correlation signals;
a weight generator operative to generate weighting factors so as to maximize a signal to interference plus noise ratio (SINR) of an estimate of the information;
a plurality of weighting arrangements disposed to generate a plurality of weighted symbol streams by processing the plurality of correlation signals in accordance with the weighting factors; and
a combiner coupled to the plurality of weighting arrangements, wherein the estimate of the information is produced by the combiner.

9. The apparatus of claim 8 wherein said weight generator is configured to compute gain characteristics of a plurality of multipath channels traversed by a corresponding plurality of multipath components of the composite signal.

10. The apparatus of claim 9 wherein said wherein said weight generator is further configured to determine a first of said weighting factors by computing a ratio of a first of said gain characteristics to a maximum of said gain characteristics.

11. The apparatus of claim 10 wherein said weight generator is further operative to determine a second of said weighting factors by computing a ratio of a second of said gain characteristics to the maximum of said gain characteristics.

12. The apparatus of claim 8 wherein each of said plurality of weighting arrangements splits a corresponding one of said correlation signals into first and second signals, each of said first signals being scaled by one of said weighting factors so as to generate a plurality of scaled signals.

13. The apparatus of claim 12 wherein each of said weighting arrangements further includes a correlator for correlating one of said second signals with a user-specific spreading signal so as to generated a channelized signal.

14. The method of claim 13 wherein each of said weighting arrangements to which is applied one said channelized signal and one of said plurality of scaled signals.

15. An apparatus for recovering information from a spread spectrum information signal included within a composite signal received from a signal propagation medium over a set of multipath channels, said apparatus comprising:
a correlation unit operative to correlate time-offset versions of the composite signal with a spreading sequence in order to produce a plurality of correlation signals;
a weight generator operative to generate weighting factors in accordance with gain characteristics of the set of multipath channels;
a plurality of weighting arrangements disposed to generate a plurality of weighted symbol streams by processing the plurality of correlation signals in accordance with the weighting factors; and
a combiner coupled to the plurality of weighting arrangements, wherein the combiner is configured to produce the estimate of the information by combining the plurality of weighted symbol streams.

16. The apparatus of claim 15 wherein said weight generator is configured to compute gain characteristics of a plurality of multipath channels traversed by a corresponding plurality of multipath components of the composite signal.

17. The apparatus of claim 16 wherein said weight generator is further configured to determine a first of said weighting factors by computing a ratio of a first of said gain characteristics to a maximum of said gain characteristics.

18. The apparatus of claim 17 wherein said weight generator is further operative to determine a second of said weighting factors by computing a ratio of a second of said gain characteristics to the maximum of said gain characteristics.

19. The apparatus of claim 15 wherein each of said plurality of weighting arrangements splits a corresponding one of said correlation signals into first and second signals, each of said first signals being scaled by one of said weighting factors so as to generate a plurality of scaled signals.
